(19) United States
(12) Patent Application Publication
(10) Pub. No.: US 2005/0273812 A1
(43) Pub. Date: Dec. 8, 2005

(54) User profile editing apparatus, method and program

(75) Inventor: Tetsuya Sakai, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/138,466

(22) Filed: May 27, 2005

(30) Foreign Application Priority Data
Jun. 2, 2004 (JP) 2004-164808

(51) Int. Cl. H04N 7/025; H04N 5/445; G06F 3/00; H04N 7/10; G06F 17/30; G06F 7/00

(52) U.S. Cl. 725/35; 725/58; 725/46

(57) ABSTRACT

An editing apparatus connected to a network for editing a user profile to which a recording device refers when determining whether each piece of content is to be recorded, the user profile including preference information related to a preference of a user, the apparatus includes acquisition unit configured to acquire at least one question related to the content, search term extraction unit configured to extract at least one search term from the question, collection unit configured to collect, via the network, relevant information related to the search term, answer candidate extraction unit configured to extract, from the relevant information, at least one answer candidate used for editing the user profile, based on a the search term and the question, and editing unit configured to edit the user profile based on all or part of the answer candidate.

### CROSS-REFERENCE TO RELATED APPLICATIONS

This application is based upon and claims the benefit of priority from prior Japanese Patent Application No. 2004-164808, filed Jun. 2, 2004, the entire contents of which are incorporated herein by reference.

### BACKGROUND OF THE INVENTION

1. Field of the Invention

The present invention relates to a user profile editing apparatus for editing a user profile that includes information concerning a user, to which a recording apparatus refers to when it performs automatic recording, and a user profile editing method and program employed in the apparatus.

2. Description of the Related Art

When users cannot enjoy in real time or would like to enjoy again later to-be-broadcasted content (e.g., TV programs, music, etc.), they sometimes perform programming for recording to see the recorded content after broadcasting. Some recording apparatuses enable users to start replay of a program from the beginning while the program is being recorded. To record, for example, a TV program, programming is generally performed by designating the channel and time of the program, or its identifier. Further, in accordance with the recent spread of digital broadcasting, a system has been put to practice, which automatically records programs corresponding to keywords designated by users, such as sports or personal names, utilizing an electronic program guide (EPG).

There are two main approaches to automatic recording of content that really meets the interests of a certain user. Firstly, to create a user profile in which their interests are expressed using a group of keywords or search conditions. Secondly, to refer to audiovisual information concerning other users who have the same interest as the certain user.

Jpn. Pat. Appln. KOKAI Publication No. 11-008810, for example, discloses the first approach, i.e., a method for searching the EPG using the search conditions corresponding to the interests of a user, although this publication does not aim to provide a programming method. Actually, however, users' interests are more vague, therefore it is often difficult for users to clearly express their interests using a group of keywords or search conditions. For instance, even if a user would like to perform programming in advance to record all works of a particular movie director, it is possible that they do not remember the titles of the works. Similarly, even if a user is interested in a particular actress, it is possible that they do not remember her name, but can merely say “that actress who plays the heroine of that movie”. Thus, a lot of time and effort are required to describe a detailed user profile.

Jpn. Pat. Appln. KOKAI Publication No. 2002-218363, for example, discloses the second approach, which is also called “collaborative filtering”. In the technique of this publication, users select an “opinion leader” who selects a program. This type of collaborative filtering is useful to some extent. Actually, however, users have different interests, and therefore, collaborative filtering is considered to have a limitation as a method for programming which program should be recorded for each user.

As described above, to realize desirable programming for users, it is necessary to create user profiles. However, users may well feel it troublesome to designate their interests, which are not always clear, using a group of keywords or search conditions.

To facilitate the preparation of user profiles, they may be determined through a dialog between the system and each user. Jpn. Pat. Appln. KOKAI Publication No. 2003-255992 discloses a system with a function for enabling users to have conversation with the system. In this system, the following conversation, for example, occurs:
System: “When does the to-be-recorded program start?”
User: “9:00 p.m.”
System: “On what channel is the program?”
User: “Channel 11”

In particular, Jpn. Pat. Appln. KOKAI Publication No. 2003-255992 describes a contrivance as to what kinds of questions should be provided to users, and how to arrange the questions, which is made in order to efficiently guide them to a desired program. However, this method merely realizes quick programming of a program designated by a user in advance, and does not overcome the above-described difficulty of clearly describing user's vague interests using a group of keywords or search conditions.

In addition, in the conventional programming systems, once the name of a sport, actor, etc., is designated as a keyword, it is difficult to rearrange the user profile to make it more suitable for the user's interests, or to follow a change in interests. Namely, it is difficult for a user not only to create a user profile from the beginning, but also to change it since they can not clearly describe their preferences.

As described above, the prior art does not provide a technique for easily editing a user profile to make it more suitable for a user's preference.

### BRIEF SUMMARY OF THE INVENTION

The present invention enables a user to easily edit a user profile so as to make it more suitable for their preferences.

In accordance with a first aspect of the invention, there is provided an editing apparatus connected to a network for editing a user profile to which a recording device refers when determining whether each piece of content is to be recorded, the user profile including preference information related to a preference of a user, the apparatus comprising: an acquisition unit configured to acquire at least one question related to the content; a search extraction unit configured to extract at least one search term from the question; a collection unit configured to collect, via the network, relevant information related to the question, based on the search term; an answer extraction unit configured to extract, from the relevant information, at least one answer candidate indicating at least one candidate for information used to edit the user profile, based on a plurality of positions of the search term and the question; and an editing unit configured to edit the user profile based on all or part of the answer candidate.

In accordance with a second aspect of the invention, there is provided an editing apparatus connected to a network for editing a user profile to which a recording device refers when determining whether each piece of content is to be recorded, the user profile including preference information related to a preference of a user, the apparatus comprising: an acquisition unit configured to acquire a character string; a collection unit configured to collect, via the network, first string information related to the character string; an extraction unit configured to extract, from the first string information, candidate information indicating candidates for information used to edit the user profile, based on the character string; and an editing unit configured to edit the user profile based on all or part of the candidate information.

In accordance with a third aspect of the invention, there is provided an editing method for use in an editing apparatus connected to a network for editing a user profile to which a recording device refers when determining whether each piece of content is to be recorded, the user profile including preference information related to a preference of a user, the method comprising: acquiring at least one question related to the content; extracting at least one search term from the question; collecting, via the network, relevant information related to the question, based on the search term; extracting, from the relevant information, at least one answer candidate indicating candidates for information used to edit the user profile, based on a plurality of positions of the search term and the question; and editing the user profile based on all or part of the answer candidate.

In accordance with a fourth aspect of the invention, there is provided a program stored in a medium, and used to cause a computer to function as an editing apparatus connected to a network for editing a user profile to which a recording device refers when determining whether each piece of content is to be recorded, the user profile including preference information related to a preference of a user, the program comprising: means for instructing the computer to acquire at least one question related to the content; means for instructing the computer to extract at least one search term from the question; means for instructing the computer to collect, via the network, relevant information related to the question, based on the search term; means for instructing the computer to extract, from the relevant information, at least one answer candidate indicating candidates for information used to edit the user profile, based on a plurality of positions of the search term and the question; and means for instructing the computer to edit the user profile based on all or part of the answer candidate.

In accordance with a fifth aspect of the invention, there is provided an editing apparatus connected to a network for editing a user profile to which a recording device refers when determining whether each piece of content is to be recorded, the user profile including preference information related to a preference of a user, the apparatus comprising: an acquisition unit configured to acquire at least one question related to the content; a search term extraction unit configured to extract at least one search term from the question; a collection unit configured to collect, via the network, web page information related to the search term, the web page information including a tag information; an estimation unit configured to estimate an answer type tag information of the question; an answer candidate extraction unit configured to extract, from the web page information, at least one answer candidate used for editing the user profile, based on the search term and the answer type tag information; and an editing unit configured to edit the user profile based on all or part of the answer candidate.

### BRIEF DESCRIPTION OF THE SEVERAL VIEWS OF THE DRAWING

FIG. 1 is a view illustrating a configuration example of a recording/reproducing apparatus according to a first embodiment of the invention;

FIG. 2 is a flowchart illustrating a procedure example employed in a question analysis unit incorporated in the first embodiment;

FIG. 3 is a flowchart illustrating a procedure example employed in a search unit incorporated in the first embodiment;

FIGS. 4A and 4B are views useful in explaining an example of a score calculation method for answer candidates employed in the first embodiment;

FIG. 5 is a flowchart illustrating a procedure example employed in an information extraction unit incorporated in the first embodiment;

FIG. 6 is a flowchart illustrating a procedure example employed in a profile management unit incorporated in the first embodiment;

FIG. 7 is a view illustrating a configuration example of a recording/reproducing apparatus according to a second embodiment of the invention;

FIG. 8 is a view illustrating an example of a question screen image presented to a user and employed in the second embodiment;

FIG. 9 is a flowchart illustrating a procedure example employed in a profile management unit incorporated in the second embodiment; and

FIG. 10 is a flowchart illustrating a procedure example employed in a question generation unit incorporated in the second embodiment.

### DETAILED DESCRIPTION OF THE INVENTION

Embodiments of the invention will be described with reference to the accompanying drawings.

### First Embodiment

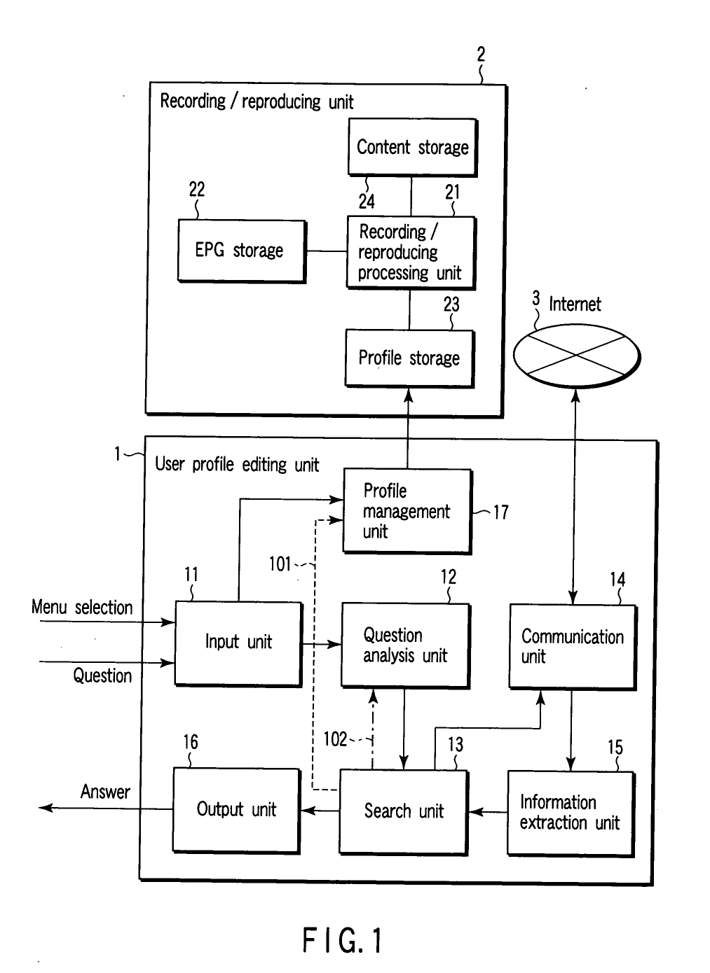

FIG. 1 is a view illustrating a configuration example of a recording/reproducing apparatus, which employs a user profile editing apparatus, according to a first embodiment of the invention.

As shown in FIG. 1, the recording/reproducing apparatus comprises a user profile editing unit 1 and recording/reproducing unit 2.

The user profile editing unit 1 is used for editing a user profile including information concerning user's automatic recording, when the recording/reproducing apparatus performs automatic recording. The user profile editing unit 1 includes an input unit 11, question analysis unit 12, search unit 13, communication unit 14, information extraction unit 15, output unit 16 and profile management unit 17.

The recording/reproducing unit 2 corresponds to a recording device, such as a video tape recorder, DVD recorder, etc., which is adapted to an electronic program guide (EPG). The recording/reproducing unit 2 includes a recording/reproducing processing unit 21, EPG storage 22, profile storage 23 and content storage 24. Basically, the recording/reproducing unit 2 may be a known device. Further, although in the embodiment, an apparatus having both the recording function and reproducing function is employed as an example, it may have only the recording function.

Although FIG. 1 shows that the user profile editing unit 1 is incorporated in the recording/reproducing apparatus, it may be an external device connectable to the recording/reproducing apparatus.

Each element in FIG. 1 will be described.

In the user profile editing unit 1, the input unit 11 is used to input a user's question (a string of natural language characters), menu selection information, etc. The input unit 11 is formed of an input device, such as a keyboard, mouse, microphone, etc.

The question analysis unit 12 analyzes a user's question (e.g., the type of an answer to the question is estimated).

The search unit 13 generates search conditions from a user's question, and searches for web pages on the Internet 3 based on the search conditions (for example, it issues a request for search to a web-page search service provided on the Internet 3, via the communication unit 14). The search unit 13 also generates answer candidates for the user's question, based on the analysis result of the question analysis unit 12 (e.g., the type of an answer to the user's question) and the information extracted from web pages that are included in search results acquired by the information extraction unit 15 via the communication unit 14.

The communication unit 14 connects the user profile editing unit 1 to the Internet 3. The communication unit 14 is formed of, for instance, a network device to be connected to the Internet.

Although in the embodiment, the Internet is utilized as a network example, another network may be utilized. In the latter case, the communication unit 14 connects the user profile editing unit 1 to another network, and searches are performed on said another network.

The information extraction unit 15 is used to acquire search results (for instance, acquire search results, as answers to a request for search, from a web-page search service provided on the Internet 3 via the communication unit 14), thereby extracting information from web pages included in the search results, the information being used by the search unit 13 to generate answer candidates for a user's question.

The output unit 16 provides a user with answer candidates, questions, etc., generated by the search unit 13. The output unit 16 can be formed of an output device, such as a display, speaker, etc.

The profile management unit 17 is provided for managing user profiles used to record content that meets users' interests (for instance, addition of a keyword to a user profile).

The question analysis unit 12, search unit 13 and information extraction unit 15 may be made to utilize the question-answering system disclosed in, for example, Prager, J. et al.: Question-answering by predictive annotation, ACM SIGIR 2000, pp. 184-191, 2000, ISBN:1-58113-226-3).

On the other hand, in the recording/reproducing unit 2, the EPG storage 22 stores the EPG acquired by an EPG acquisition unit (not shown). The EPG may be broadcasted at the same channel as content (for example, content and EPG may be combined by multiplexing), or be broadcasted by the same medium as content. The EPG may be broadcasted by a communication medium different from that of content, or may be distributed by a recording medium. Further, the recording/reproducing apparatus may acquire the EPG via a network such as the Internet.

The profile storage 23 stores user profiles. Each user profile can be, for example, edited by the profile management unit 17 of the user profile editing unit 1. However, it is a matter of course that user profiles may be modified such that they can be arbitrarily edited by users.

The content storage 24 stores the content processed by the recording/reproducing processing unit 21. There are no particular limitations as to in which form content should be stored in the content storage 24 (for instance, content may be stored in a compressed state, coded state or unprocessed state).

The recording/reproducing processing unit 21 determines, based on the EPG and each user profile, whether each item of content input by a content input unit (not shown) should automatically be recorded, and records each item of content in the content storage 24 if it is determined to be automatically recorded. If a user file contains at least one keyword (for example, a plurality of keywords connected by terms “AND”, “OR”, “NOT”, etc), and the EPG contains at least one keyword concerning an item (i.e., a program) of content (for example, a plurality of keywords arranged in series), and if a predetermined relationship is found between the at least one keyword of the user profile and the at least one keyword of the EPG, it may be determined that this item (program) should be automatically recorded. The predetermined relationship means that, for example, those keywords coincide with each other, or are in a relationship of superordinate and subordinate concepts. Of course, various variations are possible concerning the structure of the EPG or user file, and the procedure of determination, based on the EPG and user profile, as to whether each item of content should be automatically recorded.

Referring to FIG. 1, firstly, a rough description will be given of a process example performed in the embodiment, and then, a detailed description will be given of a process performed by each element shown in FIG. 1.

Firstly, to designate the type of content that should be automatically recorded (or the criterion of programming), a user inputs, using the input unit 11, a question, for example, “A soap opera starring ****”, **** indicating a particular actor name.

Upon receiving the question from the input unit 11, the question analysis unit 12 performs a process for answer type recognition, thereby determining whether the requested answer type is a personal name (PERSON), a location name (LOCATION), or a program title (TITLE). In the embodiment, since the titles of the operas are requested, the answer type is determined to be “TITLE”.

Subsequently, the search unit 13 receives the question from the question analysis unit 12, thereby generating search conditions and requesting the communication unit 14 to perform a search. From the question, “A soap opera starring ****”, three search terms, “****”, “starring” and “opera”, are acquired by a morphological analysis, and are used as search conditions. The communication unit 14 transmits the search conditions to an existing Internet search engine, thereby acquiring web-page search results and downloading the content of each web page.

After that, the information extraction unit 15 extracts information from the web pages output from the communication unit 14. As a result, a tag “TITLE” is attached to character strings, such as “xxx”, “ΔΔΔ”, etc., which indicate the names of the operas, while a tag “PERSON” is attached to a character string, such as “****”, which indicates an actor's name.

Thereafter, the search unit 13 receives the information acquired by attaching a tag indicating an answer type to each search result, and selects from the information answer candidates for the user's question, using an existing question-answering technique. As a result, character strings, such as “xxx”, “ΔΔΔ”, etc., provided with respective tags “TITLE” indicating the titles of operas are acquired as the answer candidates for, for example, “A soap opera starring ****”.

After that, the output unit 16 provides the user with the answer candidates. Using the input unit 11, the user can select one or more from the answer candidates, or may not select any of them. If, for example, the user selects “xxx” and/or “ΔΔΔ”, the keywords “xxx” and/or “ΔΔΔ” are transferred to the profile management unit 17, which, in turn, registers “xxx” and/or “ΔΔΔ” in their user file.

The above-described process enables “xxx” and/or “ΔΔΔ” to be automatically input to a user profile, even if a user cannot remember or do not know the titles of the “A soap opera starring ****” that they would like to program the recording/reproducing apparatus to record.

A detailed description will now be give of a process example performed by each of the question analysis unit 12, search unit 13, information extraction unit 15 and profile management unit 17.

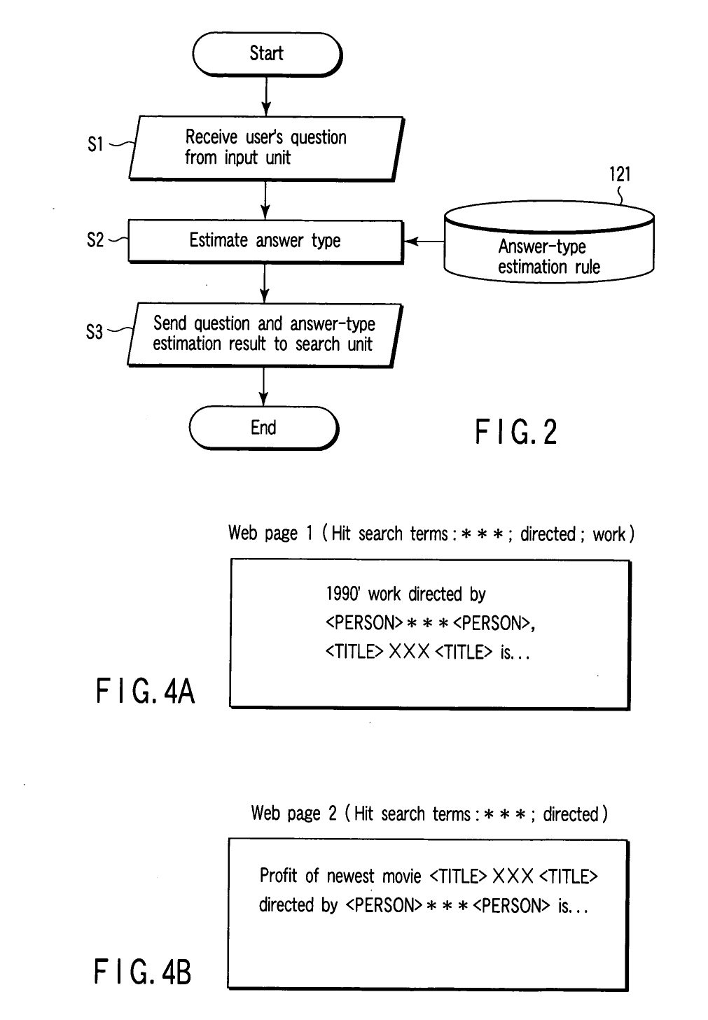

FIG. 2 shows a process example performed by the question analysis unit 12 in the first embodiment.

The question analysis unit 12 receives a question of a user from the input unit 11 (step S1), then estimates the answer type of the question using, for example, an answer-type estimation rule 121 (step S2), and sends the question and the answer-type estimation result to the search unit 13 (step S3).

The answer-type estimation rule 121 can be realized by, for example, pattern matching. Specifically, answer-type estimation can be realized by describing a rule that, for example, if the last term of a question is a “opera”, “film” or “work”, the answer type is set to “TITLE”, and if the last term of a question is a “heroine” or “actress”, the answer type is set to “PERSON”. Thus, the answer type “TITLE” is assigned to, for example, a question “movies directed by Mr. *** (*** represents a certain personal name)”, while the answer type “PERSON” is assigned to, for example, a question “the hero of xxx”.

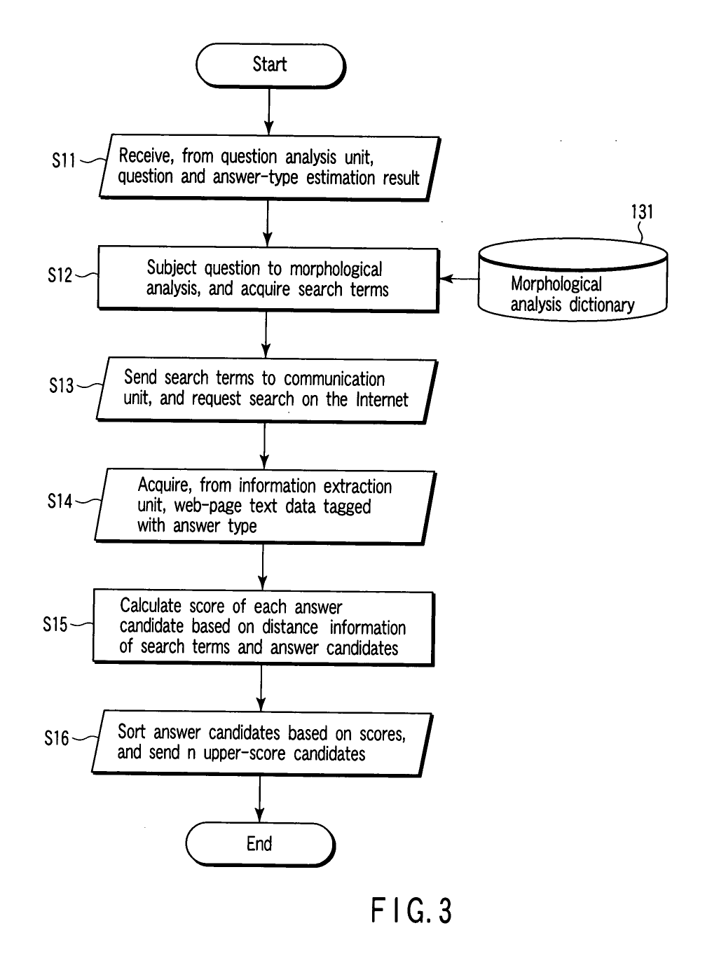

FIG. 3 shows a process example performed by the search unit 13 in the first embodiment.

The search unit 13 receives the question and the answer-type estimation result from the question analysis unit 12 (step S11), and then performs a morphological analysis concerning the question, using, for example, a morphological analysis dictionary 131, thereby acquiring search terms (step S12). As a result, search terms, such as “***”, “directed”, “work”, can be extracted from the question “movies directed by Mr. ***”. For realizing the structure of the morphological analysis dictionary 131 and morpho-logical analyses using the dictionary, known techniques may be utilized.

After that, the search unit 13 sends these search terms to the communication unit 14, and requests to search web pages using an existing search engine published on the Internet (step S13).

Subsequently, the search unit 13 acquires, from the information extraction 15, text data obtained by subjecting the search results of the web pages to an information extraction process (step S14).

By the information extraction process, in the text data of the web pages, a tag, such as “movie <TITLE>xxx</TITLE>, is attached to, for instance, “movie xxx”, while a tag, such as “movie director <PERSON>***</PERSON>, is attached to, for instance, “movie director ***”.

If the answer-type estimation result is “TITLE”, the data items of the web pages with the tag “TITLE” are regarded as answer candidates, and a score is assigned to each answer candidate, based on distance calculation concerning search terms and answer candidates (step S15).

Referring now to FIG. 4, a description will be given of an example of a score calculation method for calculating the score of each answer candidate. Assume here that three search terms, “***”, “directed” and “work”, are acquired from a user's question “movies directed by Mr. ***”, and that two web pages, “Web page 1” and “Web page 2”, are acquired as a result of a search on the Internet using the three terms. “Web page 1” as shown in FIG. 4A contains a text “the 1990's work ‘xxx’ directed by Mr. ***”, which includes all the three search terms. On the other hand, “Web page 2” as shown in FIG. 4B contains a text “the profit of the newest movie “ΔΔΔ” directed by Mr. *** is . . . ”, which includes only the search terms “***” and “directed”. Further, as shown in FIGS. 4A and 4B, tags, such as “PERSON” and “TITLE”, are attached to the web pages.

In the examples of FIGS. 4A and 4B, since the answer-type estimation result to the question “movies directed by Mr. ***” is “TITLE”, “xxx” acquired from Web page 1 and “ΔΔΔ” acquired from Web page 2 are regarded as answer candidates. In this case, if the score of each answer candidate is defined as, for example, “the sum of the reciprocals of the distances between hit search terms”, a higher score can be assigned to an answer candidate (“xxx” in the examples of FIGS. 4A and 4B) included in a text in which the number of bit search terms is larger, and the distance between each adjacent pair of the search terms is closer. The distance may be defined as the length of characters in a text character string. Alternatively, the distance may be defined by performing a morphological analysis on a text, and counting the number of words. As a result of the above process, “xxx” can be presented for the user as the first candidate, and “ΔΔΔ” is presented as the second candidate. If, unlike the examples of FIGS. 4A and 4B, the same answer candidate “xxx” is acquired from a plurality of web pages, the final answer candidate can be calculated by performing, for example, the process (majority vote process) of summing up the scores of the web pages.

Lastly, the search unit 13 sorts the answer candidates, based on their scores, and sends n upper-score candidates to the output unit 16 (step S16).

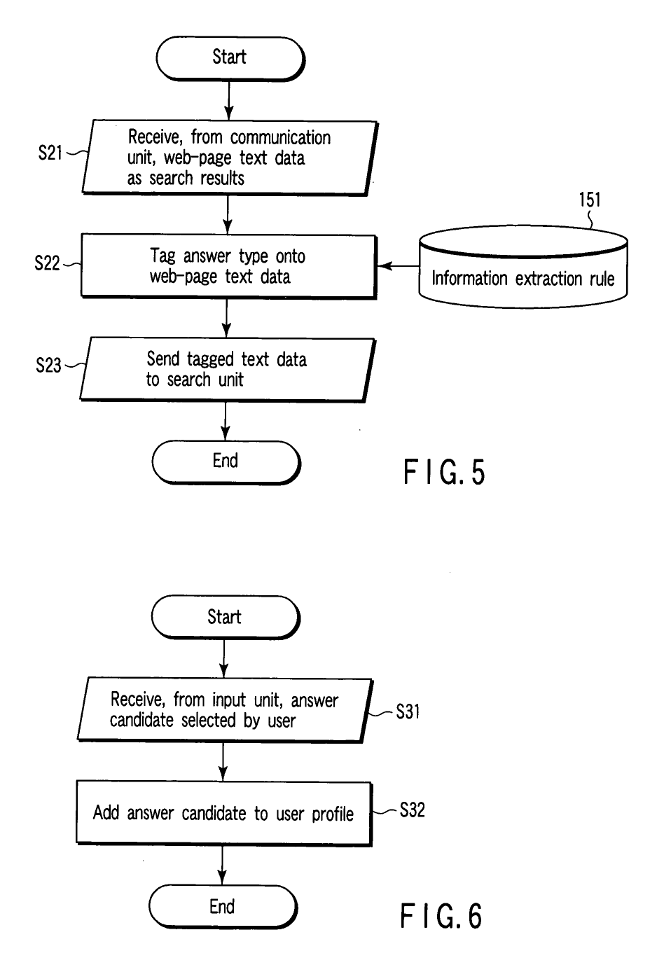

FIG. 5 shows a process example performed by the information extraction unit 15 in the first embodiment.

The information extraction unit 15 receives the text data items of web pages downloaded by the communication unit 14 (step S21), and performs the process of attaching tags, such as “TITLE”, “PERSON”, “LOCATION”, etc., to the portions of the text data items that are regarded as answer candidates, using, for example, an information extraction rule 151 (step S22). Examples of process results of the information extraction unit 15 are shown in FIGS. 4A and 4B. For realizing the structure of the information extraction rule 151 and the process of attaching the tags using the rule 151, known techniques may be utilized (for instance, information that “*** represents ‘PERSON’, and xxx and ΔΔΔ represent ‘TITLE’” may be added to the information extraction rule 151).

Lastly, the information extraction unit 15 sends the text data items with the tags to the search unit 13 (step S23).

FIG. 6 shows a process example performed by the profile management unit 17 in the first embodiment.

The profile management unit 17 receives an answer candidate selected by a user through the input unit 11, and adds the selected answer candidate to their profile stored in the profile storage 23 of the recording/reproducing unit 2. When, for example, the output unit 16 displays the first answer candidate “xxx” and the second answer candidate “ΔΔΔ”, if the user selects “xxx” through the input unit 11, a new keyword “xxx” is added to the user profile. As a result, programs that match “xxx”, for example, are automatically selected from the EPG and recorded.

The above-described processes enable users to acquire the names of works, such as “xxx”, simply by inputting the question “movies directed by Mr. ***”, and enable the acquired names (keywords) to be easily added to each user profile.

Similarly, the above processes enable users to acquire answer candidates, such as “♦♦♦”, “ . . . ” (these represent actors names), whose answer type is “PERSON”, if they input a question “the hero of movie xxx”. Thus, even if the users do not know or cannot remember the actors' names, they can add them to their profiles.

In the above description, the input by users is in the form of a question. A description will now be given of the case where the input by users is not in the form of a question (although the input is formed of natural language characters).

Specifically, assume that a user has input a character string “*** (*** represents a certain personal name)” instead of “movies directed by Mr. ***”. In this case, the input character string can be automatically determined to be a personal name, using a known technique, such as morphological analysis (the same can be said of character strings other than personal names). If a rule that “the input character string represents a personal name, the answer type is “PERSONAL” or “TITLE” is added to the answer-type estimation rule, both “PERSONAL” and “TITLE” can be acquired as results of the answer type estimation on the above input character string. After that, if the above-described process is applied to each of the cases “PERSON” and “TITLE”, both candidates for personal names related to “***”, and candidates for work names related to “***” can be acquired. It is sufficient if these candidates are presented to the user so that they can select one or more of the candidates as keywords to be added to their profiles.

Concerning the question “movies directed by Mr. ***”, the answer types can be narrowed to “TITLE”, whereas concerning the input character string “***” that is not in the form of a question, it is difficult to automatically narrow down the answer types to “PERSON” or “TITLE”. Therefore, to acquire answer candidates that meet a user's intention, if it is necessary to narrow down the answer types, when a user inputs a character string or when necessary, they may be permitted to designate an answer type, or may be permitted to input a character string in the form of a question from which the answer type is determined.

As described above, in the embodiment, even if the user's interest is vague and it is difficult for users to register detailed keywords, a user profile suitable for programming can be easily created through a dialog between each user and system.

Although the embodiment employs “TITLE”, “PERSON” and “LOCATION” as answer types, the answer types are not limited to them, but other various answer types may be employed. For instance, concerning a question “the prize granted to Director ***”, an answer type “PRIZE” is usable.

In the above description, the output unit 16 presents users with answer candidates acquired by the search unit 13, thereby permitting them to select one or more of them through the input unit 11, and the profile management unit 17 adds, to each user profile, character strings corresponding to the selected answer candidates (this will be hereinafter referred to as “the dialog mode”). Alternatively, the profile management unit 17 may be made to operate to add, to each user profile, all answer candidates acquired by the search unit 13, or answer candidates selected using a predetermined standard, as is indicated by the broken line 101 in FIG. 1 (this will hereinafter be referred to as “the automatic mode”). Further, the determination as to whether the dialog mode or automatic mode should be used may be made by users.

Moreover, in each of the dialog mode and automatic mode, a series of processes ranging from analysis, search, information extraction, answer-candidate generation, selection, to addition to user profiles may be repeated in a feedback manner, using all or part of answer candidates as new input character strings, as indicated by the dotted line 102 in FIG. 1. For instance, the following first and second processes may be performed.

Firstly, a question for asking the name of a director who directed a certain work is input, and then the name of the director is acquired as an answer candidate. Subsequently, the titles of other movies directed by the director, the name of the hero of each of the other works, the title of the work in which the director appears as an actor are acquired by inputting the name of the direction as a character string. Using the acquired name and titles as input character strings, further answer candidates are acquired. These process steps are repeated, thereby regarding, as final answer candidates, all or part of the answer candidates acquired during the repetition of the processes.

Secondly, by inputting the name of a certain director as a character string, the titles of the works directed by the director, the name of the hero of each of the works, the title of the work in which the director appears as an actor, etc., are acquired. Using the acquired name and titles as input character strings, further answer candidates are acquired. These process steps are repeated, thereby regarding, as final answer candidates, all or part of the answer candidates acquired during the repetition of the processes.

Users may be enabled to set the number of repetitions.

### Second Embodiment

In the first embodiment, addition, for example, of a keyword to a user profile is enabled by the input of a character string, such as a question from a user to the system. In contrast, in a second embodiment, addition, for example, of a keyword to a user profile is enabled, even if no question, for example, is input by a user. Specifically, in the second embodiment, addition, for example, of a keyword to a user profile is realized by generating information, which can be used in place of an input character string, based on information related to a user's interest.

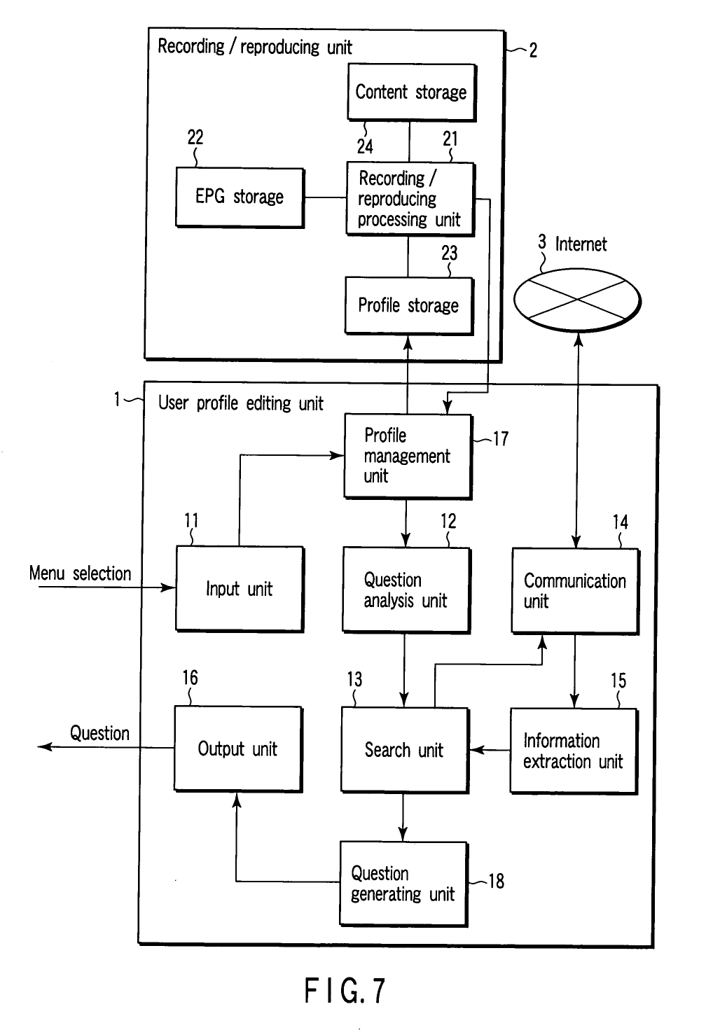

FIG. 7 is a view illustrating a configuration example of a recording/reproducing apparatus that employs a user profile editing apparatus according to the second embodiment. As can be easily understood from the comparison of FIG. 7 with FIG. 1, the configuration of FIG. 7 includes a question generation unit 18. Note that also FIG. 7 shows the case where the user profile editing unit 1 is incorporated in the recording/reproducing apparatus, but it may be an external device connectable to the recording/reproducing apparatus.

Referring to FIG. 7, firstly, a rough description will be given of a process example performed in the second embodiment, and then, a detailed description will be given of a process performed by each element shown in FIG. 7.

In the second embodiment, the points different from the first embodiment will be mainly described.

When, for example, a user has finished appreciation of part of or the entire content, the recording/reproducing unit 2 informs the profile management unit 17 of this.

Upon being informed, the profile management unit 17 generates a question for searching information related to the appreciated content. When the user has appreciated a movie with title “xxx”, the profile management unit 17 automatically generates a related question, such as “the direction who directed the movie xxx”, “the heroine of the movie xxx”, etc.

Each related question generated by the profile management unit 17 is sent to the search unit 13. The search unit 13 performs question-answering processing utilizing, for example, the Internet as in the first embodiment, thereby acquiring answer candidates for, for example, the names of the director and/or actress.

The second embodiment differs from the first embodiment in that, in the former, question-answering processing is performed on related questions automatically generated by the profile management unit 17, not on questions input by a user.

In the first embodiment, even an input character string, which is not in a question form, can be processed. The same can be said of the second embodiment. For example, the profile management unit 17 may send only the title “xxx” to the search unit 13.

The question generation unit 18 receives, from the search unit 13, the related questions and answer candidate information corresponding thereto, thereby generating a question to a user and sending the question to the output unit 16.

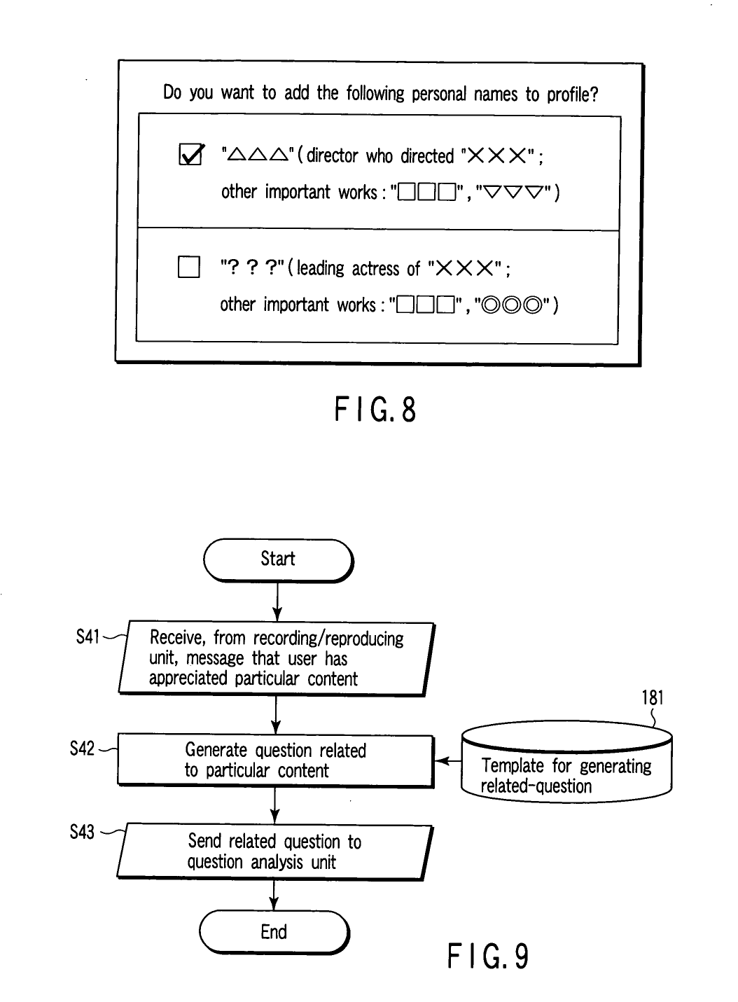

For instance, when a user has appreciated a movie “xxx”, a menu selection type question is presented to the user as shown in FIG. 8. In the example of FIG. 8, a personal name “ΔΔΔ” who directed the movie “xxx”, and a personal name “???” as the heroine of the movie “xxx” are presented to the user as candidates for keywords to be input to their profile. When the user has checked, for example, “ΔΔΔ” through the input unit 11, the user can easily add “ΔΔΔ” as a keyword to the user profile. In the example of FIG. 8, other titles “□□□” and “∇∇∇” are further presented as “other important works by the director ΔΔΔ”. The method for acquiring such information will be described later.

The second embodiment may be modified such that firstly, a question “Did you enjoy the movie xxx?” is presented to a user, and only when they answer YES, information similar to that shown in FIG. 8 is presented. Further, if the user answered NO, i.e., if they are not interested in the movie xxx, such a question as “Do you want to delete the following personal name from the profile?” may be presented to them to permit them to designate the keyword to be deleted from the profile. In any case, the profile management unit 17 changes the content of the user profile based on the answer acquired from the user.

In the above case, the following may be performed. For instance, a weighting value, which is selected from the range of a lower limit value of 0 to an upper limit value of 1, is assigned to each keyword.

If the user answered YES, and if the designated keyword is not yet registered in the user profile, this keyword is added to the user profile, with a weighting value of 1 assigned thereto. If the designated keyword is already registered, and if the weighting value assigned thereto is less than 1, the weighting value is increased. If the weighting value is 1, nothing is done.

In contrast, if the user answered NO, and if the designated keyword is not yet registered in the user profile, nothing is done. If the designated keyword is already registered, and if the weighting value assigned thereto is more than 0, the weighting value is reduced. If the weighting value is 0, nothing is done.

Alternatively, for example, if the user answered NO, and if the designated keyword is already registered in the user profile, with a weighting value more than 0, the weighting value is reduced. In the other cases, nothing is done.

In any case, the keyword may be deleted from the user profile when the weighting value becomes 0.

In the above-described examples, there are variations in the method of increasing/reducing the weighting value, and the method of using the weighting value. For instance, the weighting value may be increased/reduced by adding/subtracting a constant value (e.g., 1.0, 0.5, etc.), or by multiplying/dividing the weighting value by a constant value (e.g., 2). Further, only when the weighting value is 0, the keyword may be made invalid. Alternatively, the keyword may be regarded as valid if the weighting value is not less than a certain threshold value, and be regarded as invalid if the weighting value is less than the certain threshold value.

FIG. 9 shows a procedure example employed in the profile management unit 17 incorporated in the second embodiment.

Firstly, the profile management unit 17 receives, from the recording/reproducing unit 2, a signal indicating that a user has appreciated particular content (step S41). This can be easily realized by detecting, for example, the shift of the state of the recording/reproducing unit 2 from a content-reproducing state to a reproduction stopped state.

Subsequently, the profile management unit 17 automatically generates questions related to the above particular content (step S42). Specifically, if the user has appreciated a movie with title “xxx” as mentioned above, related questions, such as “the director of the movie xxx”, “the heroine in the movie xxx”, are automatically generated based on, for example, a template 181 generated in advance. These questions are sent to the question analysis unit 12 (step S42), thereby starting question-answering processing similar to that performed in the first embodiment.

The process performed in the second embodiment by the question analysis unit 12, search unit 13, communication unit 14 and information extraction unit 15 is basically the same as that performed in the first embodiment. Therefore, no detailed description will be given of the process. For example, by selecting first answer candidates for question-answering processing, a personal name “ΔΔΔ” can be automatically acquired as the answer to the related question “the director of the movie xxx”, and a personal name “???” can be automatically acquired as the answer to the related question “the heroine of the movie xxx”. Moreover, if a secondary related question, such as movies directed by “ΔΔΔ”, is automatically generated based on the personal name “ΔΔΔ” acquired as the answer, and question-answering processing is performed using the secondary related question, movie titles, such as “xxx”, “□□□”, “∇∇∇”, can be acquired as new answer candidates. If “xxx”, which is the title of the movie the user has appreciated, is automatically deleted, the information as shown in FIG. 8, which indicates “the other important works” excluding “xxx”, is presented to the user.

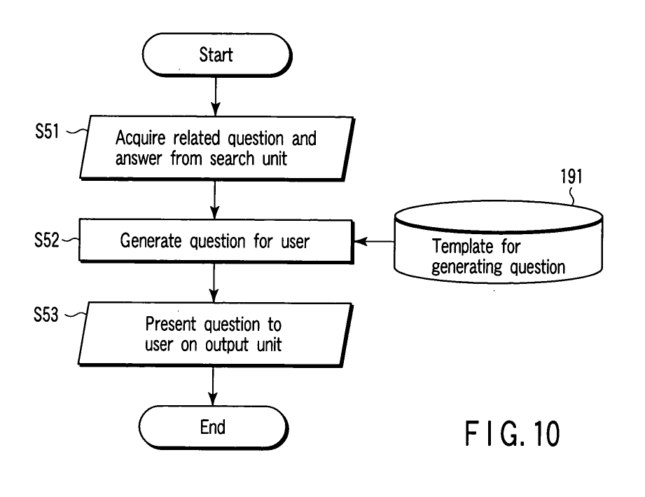

FIG. 10 shows a procedure example used in the question generation unit 18 incorporated in the second embodiment.

The question generation unit 18 receives related questions and answers from the search unit 13 (step S51), generates a question for the user using, for example, a template 191 generated in advance (step S52), and displays, on the output unit 16, information similar to that shown in FIG. 8 (step S53).

As described above, in the second embodiment, when a user has appreciated content, how to update their profile can be proposed to the user. Accordingly, even if a user has vaguely become fond of a movie “xxx”, alternatives, such as whether the director or heroine of this movie should be added as a keyword to the profile of the user, can be presented to the user.

In the above, when a user has appreciated content, the process is performed based on the title of the content. However, when a user appreciates content, processing may be performed based on data, other than the title, related to the content. Further, when a user performs processing of content other than the content that the user has appreciated, processing may be performed based on the title of the content other than the first-mentioned one, or based on data, other than the title, related to the content other than the first-mentioned one.

Note that the presently available question-answering technique is not a perfect one, therefore it is not guaranteed that the correct answer to a certain question is 100% the first answer candidate. However, since an enormous amount of redundant text data exists on the Internet, the reliability of answer candidates can be enhanced if answer candidate score calculation based on the majority vote principle, utilizing the redundant data, is performed as in the first embodiment. Further, where the types of applications used are limited as in the second embodiment, it is not difficult to enhance the accuracy of each module for question answering, such as candidate-type estimation, information extraction.

Also in the second embodiment, both the dialog mode and the automatic mode can be realized. Further, users may be permitted to set which one of the dialog mode and the automatic mode should be used. Also in the second embodiment, a series of processes ranging from analysis, search, information extraction, answer-candidate generation, selection, to addition to user profiles may be repeated in a feedback manner, using all or part of answer candidates as new input character strings.

The first and second embodiments may be combined.

Although in the embodiments, processing is performed on Japanese-language data, the invention is not limited to Japanese-language data. In the case of using, for example, English-language data, it is sufficient if known techniques, such as stemming, part-of-speech tagging, are utilized instead of morphological analysis.

Each of the above-described functions can also be realized by executing, using a computer with appropriate mechanisms, software installed therein.

Further, the embodiments can also be realized in the form of a program for enabling a computer to execute predetermined procedures, or enabling the computer to function as predetermined means, or enabling the computer to realize predetermined functions. In addition, the embodiments can be realized even as a computer-readable recording medium that stores the program.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An editing apparatus connected to a network for editing a user profile to which a recording device refers when determining whether each piece of content is to be recorded, the user profile including preference information related to a preference of a user, the apparatus comprising:
an acquisition unit configured to acquire at least one question related to the content;
a search term extraction unit configured to extract at least one search term from the question;
a collection unit configured to collect, via the network, relevant information related to the search term;
an answer candidate extraction unit configured to extract, from the relevant information, at least one answer candidate used for editing the user profile, based on a distance between the search term and the question in the relevant information; and
an editing unit configured to edit the user profile based on all or part of the answer candidate.

2. The apparatus according to claim 1, wherein the acquisition unit acquires at least one character string as the question.

3. The apparatus according to claim 1, wherein the collection unit collects at least one web page as the relevant information.

4. The apparatus according to claim 1, wherein the answer candidate extraction unit extracts the answer candidate using proximity search.

5. The apparatus according to claim 1, wherein the answer candidate extraction unit extracts the answer candidate using named entity extraction.

6. The apparatus according to claim 1, wherein the answer candidate extraction unit extracts the answer candidate using part-of-speech tagging.

7. The apparatus according to claim 1, further comprising a determination unit configured to determine a type of the answer candidate based on the question, and wherein the search term extraction unit extracts the search term, based on the question and the type.

8. The apparatus according to claim 1, further comprising a generation unit configured to generate at least one character string based on the preference information, and wherein the collection unit collects related information related to the character string, instead of collecting the relevant information.

9. The apparatus according to claim 1, wherein the editing unit includes a presentation unit configured to present the answer candidate to the user, an acquisition unit configured to acquire an instruction from the user to select data from the presented answer candidate, and an editing unit configured to edit the user profile based on the selected data.

10. The apparatus according to claim 1, wherein the editing unit edits the user profile based on the all or part of the answer candidate, without presenting the answer candidate to the user.

11. The apparatus according to claim 1, wherein:
the collection unit also collects candidate related information related to the answer candidate when the answer candidate extraction unit extracts the answer candidate; and
the answer candidate extraction unit also extracts the answer candidate from the candidate related information.

12. An editing apparatus connected to a network for editing a user profile to which a recording device refers when determining whether each piece of content is to be recorded, the user profile including preference information related to a preference of a user, the apparatus comprising:
an acquisition unit configured to acquire a character string;
a collection unit configured to collect, via the network, first string information related to the character string;
an extraction unit configured to extract, from the first string information, candidate information indicating candidates for information used for editing the user profile, based on the character string; and
an editing unit configured to edit the user profile based on all or part of the candidate information.

13. An editing method for use in an editing apparatus connected to a network for editing a user profile to which a recording device refers when determining whether each piece of content is to be recorded, the user profile including preference information related to a preference of a user, the method comprising:
acquiring at least one question related to the content;
extracting at least one search term from the question;
collecting, via the network, relevant information related to the search term;
extracting, from the relevant information, at least one answer candidate used for editing the user profile, based on a distance between the search term and the question in the relevant information; and
editing the user profile based on all or part of the answer candidate.

14. A program stored in a medium, and used to cause a computer to function as an editing apparatus connected to a network for editing a user profile to which a recording device refers when determining whether each piece of content is to be recorded, the user profile including preference information related to a preference of a user, the program comprising:
means for instructing the computer to acquire at least one question related to the content;
means for instructing the computer to extract at least one search term from the question;
means for instructing the computer to collect, via the network, relevant information related to the search term;
means for instructing the computer to extract, from the relevant information, at least one answer candidate used for editing the user profile, based on a distance between the search term and the question in the relevant information; and
means for instructing the computer to edit the user profile based on all or part of the answer candidate.

15. An editing apparatus connected to a network for editing a user profile to which a recording device refers when determining whether each piece of content is to be recorded, the user profile including preference information related to a preference of a user, the apparatus comprising:
an acquisition unit configured to acquire at least one question related to the content;
a search term extraction unit configured to extract at least one search term from the question;
a collection unit configured to collect, via the network, web page information related to the search term, the web page information including a tag information;
an estimation unit configured to estimate an answer type tag information of the question;
an answer candidate extraction unit configured to extract, from the web page information, at least one answer candidate used for editing the user profile, based on the search term and the answer type tag information; and
an editing unit configured to edit the user profile based on all or part of the answer candidate.
